(19) United States
(12) Patent Application Publication
(10) Pub. No.: US 2007/0100900 A1
(43) Pub. Date: May 3, 2007

(54) Apparatus for remote monitoring of equipment, with feed for feeding data

(76) Inventor: Nigel James Gibbins, PEVENSEY EAST SUSSEX (GB)

Correspondence Address: THE BOC GROUP, INC., 575 MOUNTAIN AVENUE, MURRAY HILL, NJ, 07974-2064, US

(21) Appl. No.: 10/576,009

(22) PCT Filed: Oct. 13, 2004
(86) PCT No.: PCT/GB04/04363

§ 371 Date: Apr. 14, 2006

(30) Foreign Application Priority Data
Oct. 14, 2003 (GB) 0324071.0

(51) Int. Cl. G06F 17/30

(52) U.S. Cl. 707/201

(57) ABSTRACT

A server (10) for connecting to equipment to be monitored, the server having an internet protocol address and comprising a database (105) for receiving and storing data from the equipment and a feed (121), for example in the form of means for generating an extensible mark-up language (XML) feedfile, for feeding data from the database to remote applications (41, 42) addressing the server. A remote computer (42) having a network connection for connecting to the server can monitor the equipment, and a news display application on that computer can store an address of the server as its source of items to be displayed and can perform a look-up of items from the server.

### FIELD OF THE INVENTION

This invention relates to the field of manufacturing plant and service installation monitoring and to information technology network components such as servers and other computers that can facilitate such monitoring, particularly (but not exclusively) at locations remote from the equipment to be monitored.

### BACKGROUND TO THE INVENTION

Modem manufacturing installations such as semiconductor plants have an increasingly complex array of sub-systems requiring monitoring, control, service and maintenance. For example, a semiconductor manufacturing plant has vacuum and abatement sub-systems as well as cryogenic systems and ultra-high-purity gas delivery systems. Other manufacturing plants have conveyor systems with staged production equipment (component insertion tools, soldering equipment, presses, ovens and the like). Similarly, service installations such as water or gas supply systems, irrigation systems and sewerage systems have pumps, valves, reservoirs and the like. Installations such as these have an increasing capacity to generate parameters and data such as flow parameters, temperature, pressure, alarms, status, electrical parameters and the like. Many of these are used locally at the installation for control of the installation. Others, such as alarms need to be reported with greater or lesser urgency to appropriate personnel, such as maintenance engineers.

Current installation monitoring equipment provides the ability to encapsulate an alarm message into a paging message of a radio-paging system and send the alarm message to a predefined pager address. A technician carrying the pager having that address receives the alarm and may be able to view some basic encapsulated information regarding the nature of the alarm, and is thus able to appropriately respond and give attention to any maintenance that may be required. Similarly, such a message can be encapsulated into an e-mail message and sent to an e-mail address or into a cellular radio short message service (SMS) message and sent to a cellular telephone. These arrangements all use private end-to-end delivery systems to deliver the specific message to the specific address. They are limited in their flexibility. For example, the recipient of the messages does not have the ability to summarise or filter the messages other than by simply ignoring them or collating them together over a period of time. There is a danger that a service engineer may fail to observe an important message because it is drowned out among messages of lesser importance. Also, such systems have limited flexibility in the addressing of a message to a service engineer. For example, if the message is addressed to a single service engineer, it may be overlooked if that engineer is not at his work station to receive the e-mail or is out of range of pager or cellular radio coverage or for other reasons. On the other hand, if the message is sent to more than one engineer, there is the danger that resources are wasted by having several personnel attending to the same event.

There is a need for a more flexible arrangement for reporting data from equipment being monitored to personnel in need of data relating to that equipment.

There is also a need for an arrangement whereby a recipient of reporting data has greater control over whether or not to receive such data and how frequently to receive it, without necessarily having to reprogram the system from which the data is delivered.

There is a further need for an arrangement that can deliver data of different levels and priorities in a more useful and meaningful manner, without having to report raw data to remote applications for sorting, analysing and summarising at the remote application. There is a need to address these shortcomings with a minimum of programming expertise and effort required at the location of the equipment being monitored and at the location of the recipient of the information.

Summary of the Invention

According to a first aspect of the present invention, a server is provided for connecting to equipment to be monitored (for example for connecting to a manufacturing installation), the server having an Internet Protocol address and comprising a database for receiving and storing data from the equipment and a feed for feeding data from the database to applications (in particular, but not exclusively, to remote applications) addressing the server.

The feed is preferably in the form of report generating software (or other means) for generating a Rich Site Summary (RSS) or similar feedfile and means for making the feedfile available on the server. The feedfile is preferably updated upon occurrence of events reported to the server from the equipment, but alternatively it may be updated from the database at regular report intervals.

The feed may comprise an extensible mark-up language (XML) file containing item tags, with the data to be fed to the applications being inserted into the item tags.

In this manner, the feedfile may be read by a web page or by syndicated newsfeed subscription software, for example at a remote computer. This allows display of messages and other information from the monitored system onto the personal computer screens of relevant personnel. In the case-of use of syndicated newsfeed subscription software, it is not even necessary for the user to have an Internet browser application on and open, because the information will simply pop up on the user's screen.

The server may have a plurality of feedfiles, each containing data received and stored from the equipment and each having a different file name. In this way, users can access different feeds from the same address using different file names. Thus, a user can select information to be viewed by appropriate file name selection. This selection is under the user's control at the remote computer. Thus, there may be a range of different feedfiles tailored to different technicians or users. Alarms may be stored in one feedfile for receipt by rapid response technicians while reports may be stored in another feedfile for receipt by system managers.

A tool is preferably provided to enable different feedfiles with different file names to be structured differently and/or to accept and deliver different data according to user requirements. The tool permits the setting up of analysis of raw data and/or summary of the data to present it in the feedfile in a more refined, pre-processed or sorted manner, making it more meaningful to the recipient who will read the feedfile off the server.

In another aspect of the invention, a manufacturing plant is provided comprising a plurality of devices, each having sensing means for sensing a parameter, and a server as described above, connected to the sensing means for receiving and storing data from the sensing means and delivering it via the feed to the remote application.

In a third aspect of the invention, a computer is provided for monitoring of equipment (especially for remote monitoring of equipment), the computer having a network connection for connecting to a server (for example a server as described above) connected to equipment to be monitored. The computer has a news display application for displaying items fed to the computer by a newsfeed wherein the news display application stores an address of the server as its source of items to be displayed and has means for performing a look-up of items from the server at regular intervals.

The read intervals are preferably settable by the user of the computer.

The computer may have a filter for filtering data received from the server and means, in the news display application, for selecting portions of all data received from the server for display.

In accordance with other aspects of the invention, combinations of the above elements are provided as well as methods of operation and computer program products comprising instructions and data which, when loaded onto an appropriate platform, cause the performance of steps of those methods.

A detailed description of preferred embodiments of the application is now provided, by way of example only, with reference to the accompanying drawings.

### BRIEF DESCRIPTION OF THE DRAWINGS

FIG. 1 is an overall block diagram of an installation such as a semiconductor manufacturing plant, connected via the Internet to the offices of a service provider such as a maintenance company.

FIG. 2 is a data flow diagram illustrating the operation of software residing on one of the servers of FIG. 1.

FIG. 3 is a pictorial representation of a web page generated by one of the servers of FIG. 1.

FIG. 4 shows certain detail of the installation of FIG. 1 to illustrate a variation on that installation.

FIG. 5 illustrates in a hierarchical arrangement a number of systems and subsystems to which the present invention can be applied.

### DETAILED DESCRIPTION OF THE PREFERRED EMBODIMENT

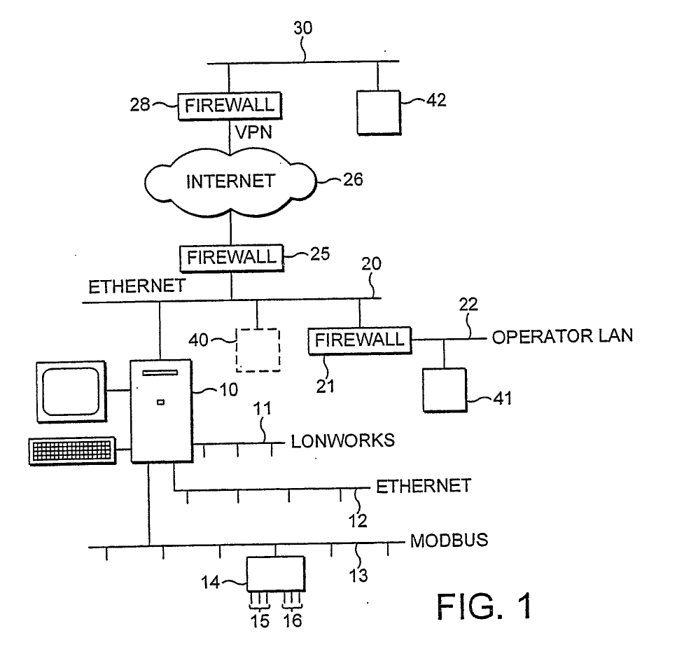

An installation such as a semiconductor plant or other manufacturing plant or indeed a service installation such as a water irrigation system has many sensors and measuring devices measuring, for different stages along the manufacturing process, parameters such as fluid and gas flow, temperature, pressure, fluid level, alarms, status, chemical sensor data vibration noise electrical parameter and times of events. For data acquisition (SCADA) system. FIG. 1 shows a SCADA system comprising a central processor 10 having one or more local area networks (LANs) 11, 12 and 13 connected to a number of items of equipment in the process via processors 14. In the example shown, LAN 11 is a proprietary Lonworks (trademark) bus, LAN 12 is an Ethernet bus and LAN 13 is of the MODBUS type. Connected to LAN 13 is a processor 14 having digital inputs 15 and analog inputs 16, which are all connected to sensors and measuring devices in the equipment to be monitored. A number of other processors such as processor 14 are connected to the various buses for the same purpose. The processor 14 typically is a programmable controller designed to gather the various signals from the equipment being monitored and convert them into a protocol suitable for the particular bus (11, 12 or 13) connected to the central processor 10. Alternatively, particularly in the case of a processor connected to the Ethernet LAN 12, the processor 14 may itself be a server.

A further LAN 20 is connected to the central processor 10 for the purpose of communicating with operators and maintenance personnel. The LAN 20 is connected by a firewall 21 to a LAN 22, here referred to as an operator LAN, being the internal network of the operator of the installation. The LAN 20 is also connected through a further firewall 25 to the Internet 26 and via the Internet through a further firewall 28 to the LAN 30 of a service provider such as a maintenance service provider providing maintenance services to the installation The LAN 20 between the firewalls 21 and 25 is typically known as a DMZ (demilitarised zone), being less secure than the operator LAN 22.

Various other servers and computers can be connected to the various LANs. In particular, an optional server 40 is shown connected to the Ethernet LAN 20, a server 41 is shown connected to the operator LAN 22 and a further server 42 is shown connected to the LAN 30. These will be described in greater detail below.

In operation, equipment being monitored generates digital and analog signals and interrupts which are received by the inputs 15 and 16 of the processor 14. Some or all of this data and these signals need to be communicated to a maintenance engineer who is not necessarily located at the same site or to the same local area network. In prior art arrangements, it has been known to use these signals to generate paging messages which are sent to the wireless pager of a technician. Such paging messages would typically be sent from the central processor 10. Such an arrangement is inflexible and can be of little value if the messages being sent are too frequent or if significant but infrequent messages are lost among frequent but insignificant messages.

Accordingly, in the preferred embodiment of the invention, software in the central processor 10 receives all the events generated by the various processors 14 and summarises these in summarising and reporting software to generate more meaningful messages targetted at different recipients. These messages are made available on the central processor 10 operating as a server and can be picked up by a remote computer such as computer 42 on the network of the service provider company. The messages to be picked up are made available from the central processor 10 in the form of a feedfile, particularly a Rich Site Summary (RSS) feedfile.

RSS is a format for syndicating news. A typical software package for reading such news is commonly known as a newsfeed reader. These collect the news in the background at user configurable intervals and often warn with a pop-up window in the system tray that a fresh news item has appeared. A mouse-click on the news headline then causes a short description of the news to be presented, together with a link to the source of the news item. The original news web page can then be opened in an RSS reader browser or default browser window by further clicking on the link.

The RSS feedfiles available from the central processor 10 are accessed remotely using a newsfeed reader on the computer 42. This reader addresses the IP address of the central processing unit 10 and aparticular RSS file stored on that processing unit, so that messages, alarms and other information pop up on the screen of the computer 42 in a manner that is under the control of the operator of the computer 42. Alternatively, the RSS feedfiles are used to fill in or “populate” data areas of a web page generated by a web server 41 and accessed by means of a browser on computer 42, which addresses the internet protocol (IP) address of the server 41. How these arrangements are achieved is described now in greater detail.

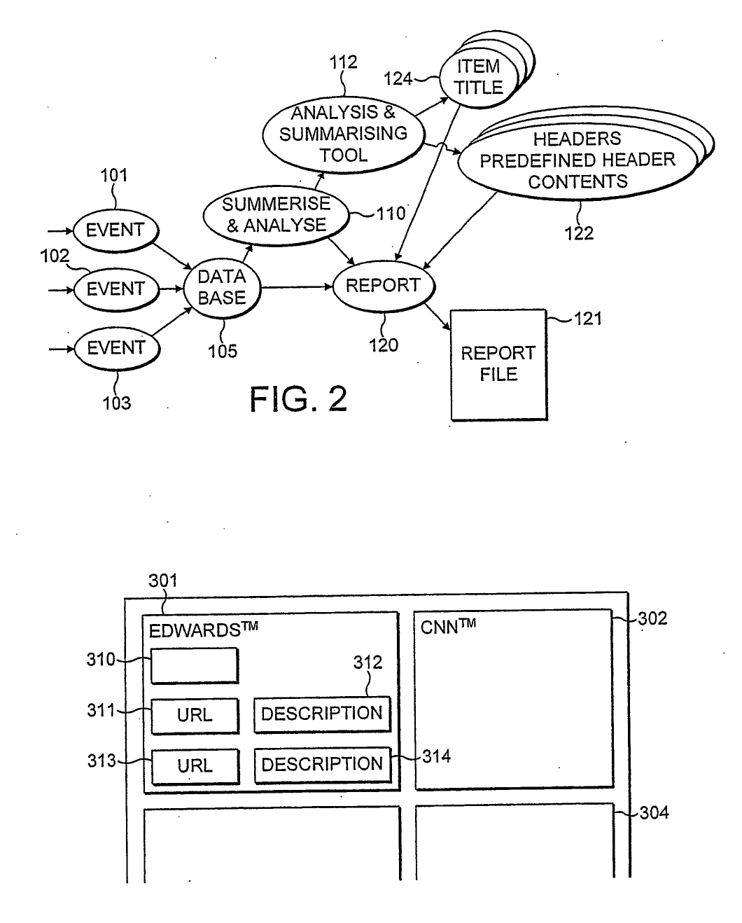

Referring to FIG. 2, a data flow diagram illustrating operation of certain software in the central processor 10 is shown Events or readings taken from the digital and analog inputs 15 and 16 cause the flow of event information 101, 102 and 103 into the software program. These events may occur at regular intervals and with high frequency (e.g many events per second) or they may include events that occur infrequently and irregularly, such as alarms. Three such events are shown by way of example only. The events are stored in a database 105, from which they are accessed by summarising software 110. The summarising software 110 continuously monitors the data stored in database 105 and performs summarising and analysing operations on the data. For example, where there are a number of different pumps performing a similar function, the summarising function of software 110 will generate a single concatenated datafile summarising the status of all the pumps of equal standing at a given time or, for example, for a given pump it will provide a summary report for the operation of the pump over a predefined time period. These are just examples of the many and varied summarising functions that can be performed. Other examples would be to take the data from the database 105 and summarise it by stage of production or by product or by workshift or in other ways. An analysing and summarising tool 112 is provided to allow a user to select the analysis function required (e.g. from a list of statistical functions) and the parameters to be analysed and the format (e.g. header and contents or rows and columns) of the report to be delivered. The tool 112 causes headers and header content files 122 to be stored and item title files 124 to be stored.

The software 110 can also analyse the data in the database 105. For example, it can compare one stream of parameters with another stream of parameters and look for correlations or anomalies. It can measure flow into a given stage and compare it with flow out and search for discrepancies indicative of leakage. It can perform rolling average (integration) analysis or look for unusual spikes (differentiation) in the data. These are just examples of the many analysis functions that can be performed. The output of the summarising and analysing software 110 is delivered to a reporting module 120. It may be noted that certain data items need not be summarised or analysed and can be reported directly from the database 105 to the reporting software 120. By way of example, there may be alarms that need not be summarised or analysed but simply need to be reported.

The reporting software 120 creates a report file 121 in RSS format. RSS is a format designed to allow Web site content to be easily syndicated. The syndicated content can be integrated into other Web sites, or can be viewed by individuals via an assortment of desktop applications. For example, CNet's News.com (trademark) site can be syndicated, meaning you can add the News.com's latest headlines to a web site.

An RSS feed is a Web-accessible file that can be accessed by those wishing to consume the respective content. In this way the web site's content is said to be “syndicated”. The file is an XML file in the proper RSS standards format. Typically, an RSS feed is a static .xml that is periodically updated by some background process, but ASP or ASP.NET Web pages can be used to dynamically generate the RSS feed's content.

An example of an RSS feedfile is as follows.

<?xml version=“1.0” ?>
<rss version=“2.0”>

<channel>

<title>Main System Server Report</title>
<link>http://www.ourmonitoringsystem.com</link>
<description>System Status Report</description>
<item>

<title>Pump 4 Oil Level Alarm</title>
<link>http://www.ourmonitoringsystem.com/alarms.htm</link>
<description>Oil level alarm pump 4 at 15:30 on 12Sept03</description>

</item>
<item>

<title>Pump 3 Water Flow Warning</title>
<link>http://www.ourmonitoringsystem.com/warnings.htm </link>
<description> Water flow warning pump 3 at 07:30 on 12Sept03</description>

</item>
...

</channel>

</rss>

In this feedfile, the first two lines of code merely indicate the version of XML software being used and indicate that the file is an RSS file with a particular version number. At the end of the file, the operators “/RSS” indicates the end of the file. Between the second line and the last line, the channel is opened and closed. There may be more than one channel in a file. Initially, upon opening the channel, there is a channel title with a channel link and a channel description. These various items are put into the report software 120 from the predefined header and header content files 122. The title is selected to indicate the subject that is common to all the subsequent items being reported. The link is a link to a computer on the network where details of the events can be found (for example a link to computer 10, computer 14 or computer 41). The description is a text file that is generally longer than the mere title. Following the channel definition, there is a sequence of items. In the example shown, there are just two items, each commencing with an “item” tag and ending with a “close” tag. Each item, has a title a link and a description The item title is drawn from the predefined title files 124. The link is typically a sub-page within the page at which the channel is found, and the description is the content of the report or is derived from the content of the report from the summarising and analysing software 110 or from the database 105.

The above RSS file has as its root the <rss> node. Following this there is one <channel> node. Inside the channel node there must be the <title>, <link>, and <description> nodes. The actual content to be syndicated appears in the <item> tags. Each <item> tag must have at least a <title> or <description> tag. (For a much more thorough discussion of the RSS spec, see, for example, http://backend.userland.com/rss.)

The entire report file 121 has a file name which will uniquely identify that file on the central processor 10. The file is stored in the central processor 10 and its file name can be found in the directory of that central processor. It is now available to be picked up from any one of a number of computers in different manners as will be described.

Processor 10 preferably has numerous RSS feeds and each RSS feed has, for example, between 2 and 10 <item> tags, one for each of up to 10 latest reports. This RSS feed is generated in one of two ways:
the feed can be generated as a static .xml file (e.g. every half hour) by some background process, or
the feed can be dynamically generated every time it is requested by having the RSS feed be an ASP page that generates the needed XML

The preference between these options depends on how often the content is updated If new content is added just once a day, or twice a day, then the static approach is likely to be preferred. However, if the content changes frequently, a dynamic RSS feed might be the better option. The dynamically generated feed is preferred for the present controls based application.

Referring to FIG. 3 it will now be described how the file 121 is used to generate a web page by a computer 41 which is typically located on the operator LAN 22 (but could be connected on one of the other LANs or at another point in the Internet 26).

Stored on computer 41 is a web page template that comprises a number of fields such as fields 301, 302, 303 and 304. Within the first of these, there are sub-fields 310 to 314. Software in the computer 41 populates these fields with data from the RSS file available on processor 10. Computer 41 addresses processor 10 by its unique IP address and looks for one or more RSS files, either by name or by data of generation or in some other way. It receives that file or those files from processor 10 and uses it or them to prepare a consolidated web page. It places the channel title in field 310, making the content of field 310 into a link to the channel link. Similarly, it places the first item title in the field 311 and makes this a link to the first item link. It places the first item description in field 312. Similarly, it places the second item title in field 313 with a link to the second item link and places the second item description in field 314. If there are further items, these can similarly be included in field 301, either by providing additional boxes in the field or by providing a scrollable field with an unlited number of boxes. Other fields such as field 302, 303 and 304 can be populated with other information. For example, other streaming news media information may be placed in field 302, such as news from a Cable Network News (trademark) channel and the like.

The completed web page as shown in FIG. 3 is uniquely identifiable on computer 41 by a unique URL having a sub-address perhaps identified by the name of the RSS file from which it is generated. If there are several RSS files on the processor 10, each can be built up as a web page by the computer 41, each having a separate URL sub-address. In order now to view the summary and report data, all that is necessary from the point of view of the maintenance engineer using computer 42 is for the browser of the computer 42 to address the web pages generated on computer 41. The unique URL with its sub-address identifying the particular page on computer 41 is entered into the browser of the computer 42 and, through the virtual private network set up between firewalls 28 and 25, the computer 42 is able to view the web page shown in FIG. 3.

As an alternative to the web page illustrated in FIG. 3, the computer 42 can be provided with syndicated newsfeed subscription software (sometimes referred to as news aggregator software) such as is provided by Newsgator Technologies of 2948 West Creek Trail, Highlands Ranch, Colo. 80129, USA, which provides RSS feed integration with Microsoft Outlook (trademark). The user of the computer 42 provides the syndicated newsfeed subscription software with the IP address or URL of the central processor 10 and (preferably) the specific page or pages at that address which are of interest to the user of the computer 42. By “pointing” the syndicated newsfeed reader software to the specific address of the server to which the manufacturing plant or other equipment is connected), the syndicated newsfeed reader software on the computer 42 will open up on the screen of the computer 42 and deliver the reports generated by the processor 10 in a clear and logical format. The exact format is not as controllable as in the case of the website shown in FIG. 3, but syndicated newsfeed software typically adopts a similar format of presenting the item title, the link and the item description, followed by the next item title, link and description, etc. Thus, the presentation of the reports will follow the presentation in file 121 of FIG. 2.

The user of computer 42 can select the read interval, i.e. the interval at which the computer 42 refreshes its RSS file from the central processor 10. This read interval 10 may be infrequent (e.g. once per day) or may be a sufficiently brief interval to ensure that every update to the RSS file on central processor 10 is captured by an update at the syndicated newsfeed reader in computer 42. Preferably, the read interval set for the computer 42 is no greater than the report interval at which a file 121 is refreshed. The syndicated newsfeed reader preferably determines whether an RSS file that it reads from the central processor 10 has been updated. This is preferably achieved by examining the time stamp for the file, typically contained in the file nane, but may be carried out by examining a time stamp within the file or by performing content comparison, comparing the content of a newly read RSS file with the content of the immediately preceding file to identify whether any update has taken place.

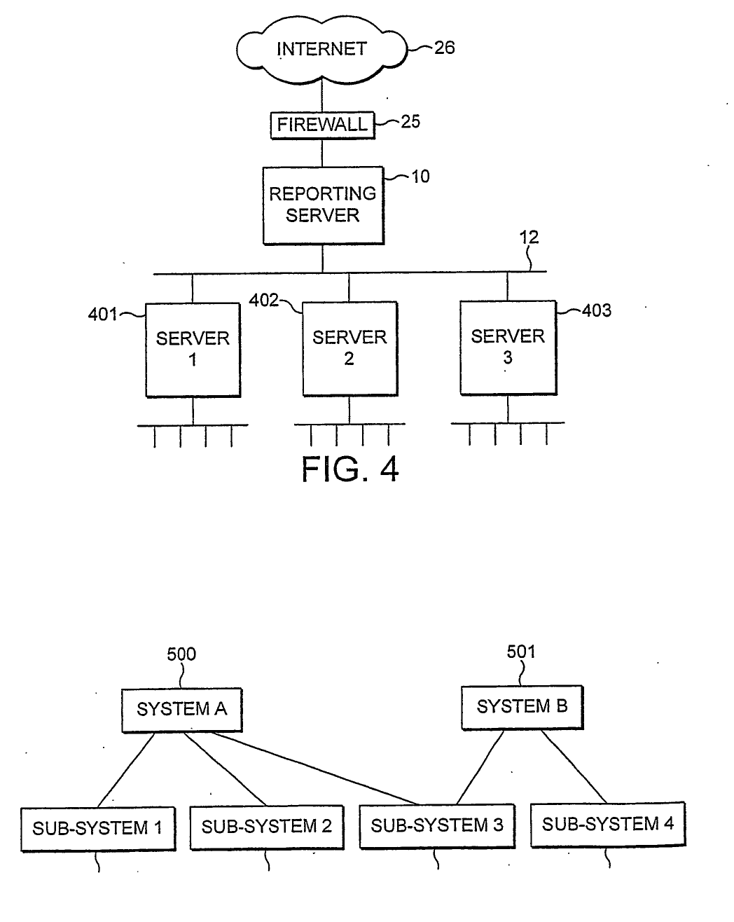

Referring to FIG. 4, the Internet 26, firewall 25 and central processor 10 of FIG. 1 are shown connected to the Ethernet 12. In this example, there are three processors 401, 402 and 403 connected to the Ethernet 12, each of these processors being a server. Each server has its own unique IP address. This arrangement is illustrated for the purposes of explaining two variations on the arrangement described with reference to FIG. 1. First, it is possible for the feedfile 121 generated in the processor 10 to provide links to one or more of the processors 401 to 403. For example, where one of the items in the feedfile 121 gives a link, that link can directly address the processor 401 (or one of the other processors) instead of addressing a page in the central processor 10. In this way, the engineer or operator observing the feedfile from a remote application has the ability to link directly to the processor from which the relevant data is being generated.

A second useful feature of the arrangement of FIG. 4 is that any one of the processors 401 to 403 can generate its own feedfile. Of course, a browser wishing to address a feedfile on one of the servers will need to direct its syndicated newsfeed subscription software to a different IP address as well as to the file stored at that address. Thus, it is possible for a remote computer to selectively address a feedfile being stored at more than one server (identified by IP address) and more than one page stored on any one of those servers.

The data produced/required to be stored on each web-serving system or sub-system is as follows:
Live Data—the data that represents the current state of the system and any attached sub-systems
Historical Data—archived “Live Data” stored covering a defined period from the local system and any attached sub-system
Events Data—Alarms, warnings and other defined events from the local
News Feed—A collection of advisories that new “Events Data” items have occurred.

As well as storing the data in a database, other formats can be used. For example, an XML data structure, XLS style sheets and web-pages can use these files to present the data to the user and/or data recording system. All “Live Data”, “Historical Data”, “Events Data” and “Snap-Shot Data” is preferably stored in XML structured files.

Any event, be that a warning, alarm or other event (as defined by the user/designer) will cause:
The creation of a “Snap-Shot” Data file that will hold the “Live Data” recorded at the time of the defined event
The creation of a “News Feed” Rich Site Summary (RSS) file and/or News Syndication Javascript, VBScript (or equivalent) file. These will point the user to the relevant file that will allow him or her to view both the current “Live Data” and the “Snap-Shot Data” of the relevant event.

“Live Data”, “Historical Data” and “Events Data” files consist of locally generated data items plus data recorded from similar files on associated sub-systems either stored as “child” items within the XML structure of a single file (direct) or stored as separate file copies of the sub-system files (indirect). This is illustrated with respect to FIG. 5, in which two systems 500 and 501 are shown with four subsystems 510 to 513. Subsystems 510, 511 and 512 are “child” systems of system 500. Subsystems 512 and 513 are “child” systems of system 501. Note that a subsystem may be a child of more than one system. So, for example, the “Events Data” file(s) of system A will also directly or indirectly hold the “Events Data” files of sub-systems 510 and 511. There may also be occasions where a sub-system is shared—in this case it could be that all of the data from sub-system 512 is added to the files of System A or it may be the case that only an appropriate sub-set is added.

A SCRIPT file (such as a VBScript or Javascript file) can be read as an include file by another system to advise the reader of the relevant web-page that a event has occurred on a monitored system. Such an arrangement provides a web-page designer with another way of embedding newsfeed status information about another control system within a web-page.

A example Javascript File is as follows.

// Control System Newsfile
document.write( “<!--ARTICLE-->\n” );
document.write( “\n” );
document.write( “<p> <b><a
href=http://[your-server]/events.htm target=\“ blank\” >Water Flow Failure in Device
XYZ</a></b> <font size=1>at 16:45 on 17/03/2003</font> \n” );
document.write( “ </a> \n” );
document.write( “<p>\n” );
document.write( “\n” );
document.write( “\n” );
document.write( “\n” );
document.write( “<!--ARTICLE-->\n” );
document.write( “\n” );
document.write( “<p> <b><a
href=http://[your-server]/events.htm target=\“_blank\”>Oil Level Warning in pump
abc</a></b> <font size=1>at
17:15 on 17/03/2003</font> \n” );

In the above, [your-server] could be device processor 14 or the higher level processor 10 as preferred.

In this manner, the invention described and claimed uses the technologies applied to advising the world of key “breaking” news events and applies it to web based control systems. This provides users with a new way to get error/information messages from their monitored system(s) onto their PC screens using existing technologies and without the need for them to have their internet browser on and open.

By using this technique, control engineers can set their PCs, using off-the-shelf news feed technologies to read the generated news-feed articles or headlines emerging from any user selected control systems.

The above detailed description has been given by way of example and modifications of the invention can be made by, and further advantages will be apparent to, one of ordinary skill in the art, within the scope of the invention.

1. A server for connecting to equipment to be monitored, the server having an internet protocol address and comprising a database for receiving and storing data from the equipment and a feed for feeding data from the database to remote applications addressing the server.

2. The server according to claim 1 wherein the feed is updated upon occurrence of events reported to the server from the equipment.

3. The server according to claim 1 wherein the feed is updated from the database at regular report intervals.

4. The server according to claim 1 further comprising an active server page file or active components that interrogate(s) the database to create a dynamic file that is accessible from the remote applications.

5. A server according to claim 1 wherein the feed comprises an extensible mark-up language (XML) file containing item tags and wherein the data to be fed to remote applications is inserted into the item tags.

6. The server according to claim 5 wherein the XML file is structured as a Rich Site Summary (RSS) feed.

7. The server according to claim 5 wherein each item tag has a title part, a link part and a description part.

8. The server according to claim 1 wherein the server has a plurality of feedfiles, each containing data received and stored from the equipment and each having a different filename, whereby users can access different feeds from the same address using the different file names, whereby a user can select information to be viewed by appropriate file name selection.

9. The server according to claim 8 comprising a tool to enable different feedfiles with different file names to be structured differently and/or to accept and deliver different data according to user requirements.

10. A manufacturing plant comprising a plurality of devices, each having sensing means for sensing a parameter, and a server in accordance with any one of claim 1 connected to the sensing means for receiving and storing data from the sensing means and delivering it via the feed to the remote applications.

11. The manufacturing plant according to claim 9 wherein the parameters are selected from: flow parameters, temperature, pressure, alarms, status, chemical sensor parameters, time, vibration, noise and electrical parameters.

12. A computer for remote monitoring of equipment, the computer having a network connection for connecting to a server connected to equipment to be monitored and having a news display application for displaying items fed to the computer by a news feed, wherein the news display application stores an address of the server as its source of items to be displayed and has means for performing a look-up of items from the server at regular read intervals.

13. The computer according to claim 12 wherein the read intervals are settable by a user of the computer.

14. The computer according to claim 12 further comprising a filter for filtering data received from the server and means, in the news display application, for selecting portions of all data received from the server for display.

15. The computer according to claim 12 wherein the news display application operates to cause sequential items to be displayed while the computer is active without separate selection by the user.

16. The equipment monitoring system comprising a server according to claim 1 and a computer according to claim 12 connected to the server via an intranet or the Internet.

17. A method of operation of a server connected to equipment to be monitored, where the server has an internet protocol address and a database for receiving and storing data from the equipment, the method comprising generating a feedfile containing reports of parameters being monitored in the equipment and storing the feedfile on the server in a manner such that it can be read by a remote application addressing the server.

18. A computer program product comprising instructions and data which, when loaded onto a server having an internet protocol address and a database for receiving and storing data from equipment being monitored, cause the server to generate a feedfile containing reports of parameters being monitored in the equipment and to store the feedfile in a manner such that it can be read by a remote application addressing the server.

19. A method of operation of a computer for remote monitoring of equipment, comprising providing a network connection for connecting to a server connected to the equipment to be monitored, providing a news display application for displaying items fed to the computer by a news feed, storing, in association with the news display application, an address of the server as its source of items to be displayed and performing a look-up of items from the server at regular read intervals.

20. A computer program product comprising instructions and data which, when loaded onto a computer having a network connection for connecting to a server connected to equipment to be monitored, cause the computer to:
execute a news display application;
uniquely address a feedfile located at an address identifying the server;
perform a feedfile look-up from the server at regular read intervals; and
display items fed to the computer by the news display application in combination with the feedfile.
